(19) United States
(12) Patent Application Publication
(10) Pub. No.: US 2007/0203026 A1
(43) Pub. Date: Aug. 30, 2007

(54) Methods for controlling bermudagrass, bermudagrass hybrids and other weedy monocot and dicot species

(75) Inventors: Ronny R. Duncan, Boerne, TX (US); Tim Hiers, Naples, FL (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: TurfEcosystems, LLC, Naples, FL (US)

(21) Appl. No.: 11/711,095

(22) Filed: Feb. 27, 2007

Related U.S. Application Data
(60) Provisional application No. 60/776,669, filed on Feb. 27, 2006.

(51) Int. Cl. A01N 59/08

(52) U.S. Cl. 504/174

(57) ABSTRACT

The invention describes a general method of controlling and/or substantially eliminating weeds by applying compositions comprising chloride ion-containing compounds having chloride concentrations that effectively control the growth of and/or substantially eliminate weedy species such as bermudagrass and other grassy and broadleaved weeds, without harming salt-tolerant grasses such as Seashore paspalum or the environment. The compositions may also include chelants or other additives that enhance movement of the composition into the weedy species shoots and other grass components for control as well as other chemicals or compounds applied prior to or after application of the compositions to control and eliminate weedy species. The methods of the invention are particularly useful in developing, managing and maintaining golf courses, vegetative or seed production fields, sports fields, lawns, landscapes and any other paspalum plantings (e.g., forages, land stabilization, bioremediation).

### CROSS-REFERENCE TO RELATED APPLICATIONS

This application claims the benefit of U.S. Provisional Application Ser. No. 60/776,669, filed on Feb. 27, 2006, the disclosure of which is herein incorporated by reference in its entirety.

### BACKGROUND OF THE INVENTION

(i) Field of the Invention

The invention relates to novel methods for controlling the growth of grasses such as bermudagrasses in an environment such as seed, sprig or sod production fields, lawns, landscapes, sports fields or golf courses. More particularly, the invention encompasses methods for controlling and/or substantially eliminating bermudagrasses and other weedy species in any paspalum grass planting by applying chemical compositions comprising chloride concentrations at levels that effectively control the growth of and/or substantially eliminate bermudagrass species, bermudagrass hybrids and other monocot grassy and dicot broadleaved weeds without harming the paspalum grass or the environment.

(ii) Description of the Related Art

Seashore paspalum (Paspalum vaginatum Swartz) is a halophytic grass in the Panicoideae subfamily and Poaceae family. This environmentally sustainable grass has multiple uses, including planting in seed, sprig and sod production fields, as a recreational turfgrass (useful for lawns and landscapes, sports fields and golf courses), forages for herbivores and for land reclamation and bioremediation. In particular, Seashore paspalum is often used in golf courses, sports fields, and lawns/landscapes that are located near salt water because it displays a high level of natural salt-tolerance that can also withstand poor-quality, non-potable and recycled salinized irrigation water and saline-challenged soil conditions. Due to these advantageous properties, Seashore paspalum is normally grown in environmentally stressful and ecologically sensitive areas dominated by moderate or high levels of salinity or poor water quality. However, some weedy species such as bermudagrass compete with paspalum grasses and threaten the effectiveness of using paspalum in pristine turfgrass situations. Accordingly, controlling and/or eliminating these competing weedy species is essential for the long term sustainability of paspalum varieties (cultivars), especially in recreational turfgrass, grass production fields and land stabilization situations.

Methods of using herbicides to control or eliminate weedy species are known in the art. Chemical herbicides are typically categorized according to the time of application (e.g., pre-emergence or post-emergence herbicides). Pre-emergence herbicides are applied prior to planting of seeds or vegetatively propagated organs such as stolons, rhizomes, sprigs, plugs, or sod for control of germinating seeds or rooting propagules without harming the desired plant species. Post-emergence herbicides are applied after planting and over the top of establishing or established plants for control of unwanted plant species. Herbicides may also be classified as selective (targeting specific species of monocots and/or dicots), non-selective (targeting all species as defoliants, eradicants, or desiccants), systemics (absorbed via the root or shoot system and dispersed through all or a portion of the plant), or growth regulatory (disrupts the hormonal activity in some portion or all of the plant).

Examples of herbicides that have been used in conjunction with paspalum grasses include: herbicides actually labeled for seashore paspalum such as RONSTAR G® (oxadiazon), MANAGE® or SEMPRA® (halosulfuron), DIMENSION® (dithiopyr), BARRICADE® or CAVALADE® (prodiamine), and SPEEDZONE SOUTHERN® (carfentrazone). Additional herbicides with a warm season grass label that have been used on paspalum include: MANOR® (metsulfuron), BASAGRAN® (bentazon), DRIVE® (quinchlorac), TRIMEC SOUTHERN® (MCPP+2,4-D+dicamba), KERB® (pronamide), PENDULUM® or PRE-M® (pendimethalin) and VANQUISH® (dicamba). However, none of the above herbicides will control or eliminate bermudagrass species in paspalum grass. In addition, the current herbicide arsenal (actual labeled for paspalum, listed above) that is safe to use on Seashore paspalum is limited because of the recent introduction of the grass into the turf industry for environmental sustainability and persistence. Additional research has been conducted on the following conventional herbicides that exhibit some degree of phytotoxicity response on bermudagrass species such as ROUNDUP® (glyphosate), REWARD® (diquat), FUSILADE® (fluazifop-butyl), ACCLAIM® (fenoxaprop), CONFRONT® (triclopyr+chlopyralid), PROGRASS® (ethofumesate), and ENVOY® (clethodim). All of these herbicides have additional degrees of phytotoxicity on seashore paspalum.

Both monocot and dicot weedy species that are inherent in regions dominated by moist and saline ecosystems have proven difficult to control. For example, common and hybrid bermudagrass is one weedy genus that is found in these ecosystems and competes directly with Seashore paspalum. In particular, Bermudagrass and most other monocot and dicot weedy plant species aggressively dominate nitrogen uptake in competing environments and greedily use those nitrogen compounds to the detriment of surrounding plant species (e.g., paspalum grasses). On the other hand, Seashore paspalum has a low requirement for nitrogen and other nutrients, and a very efficient uptake mechanism for nutrients that contributes to its phytoaccumulation attributes and bioremediation capabilities. Its inherent, broad salinity tolerance provides the capability to withstand up to ocean level chlorides (˜19,000 ppm) and other elevated total salt concentrations.

Current methods of attempting to control bermudagrass species or hybrid combinations in plantings of Seashore paspalum have used specific or combined herbicides (listed above) or plant growth regulators (TRIMMIT® or paclobutrazol, CUTLESS® or fluprimidol, PRIMO® or trinexapac-ethyl, PROXY® or ethephon) in conjunction with or in combination with some concentration of seawater or other sources of saline irrigation water. However, these treatments have been inconsistent in controlling and totally unsuccessful in eliminating bermudagrass in paspalum plantings. In particular, herbicides that are phytotoxic on bermudagrass species have partial or significant residual phytotoxicity on paspalum and cannot be used without damaging or diminishing paspalum canopy density and grass quality, therefore increasing the likelihood for predisposition to disease/insect attack and establishment of unwanted species. The use of seawater or other sources of saline irrigation water in combination with the herbicides and growth regulators discussed above often results in an excess of sodium (Na) deposition into the ecosystem. This excess level of sodium leads to specific ion toxicity problems in root tissues of many plants and to soil structure deterioration (i.e., sodic or saline-sodic soil) with consistent elevated Na levels deposited into soil profiles from saline water.

The only effective control and/or elimination of bermudagrass in paspalum plantings has been complete excavation of the contaminated area, followed by infusion of new soil and replanting of the paspalum. Bermudagrass is difficult to eliminate due to its uncanny ability to store significant carbohydrate reserves in rhizomes (underground roots) and stolons (above ground roots), coupled with inherent long term survivability of these regenerating organs. The above listed herbicides that are phytotoxic on bermudagrass are not 100% effective in eliminating the grass. Most of the bermudagrass phytotoxic herbicides, either with or without seawater or varying levels of saline water, will burn back (temporarily control) the surface shoot canopy of the bermudagrass, but have been ineffective in totally eliminating the underground regenerative organs. Normal irrigation practices and rainfall will dilute the salinity impact from initial application of brackish or seawater additions, rendering this control strategy undependable. Continuous applications of high salinity irrigation water is not recommended due to the accumulative loading of salts (especially sodium) into the ecosystem and the need to manage salts in the grass plantings.

Paspalum is being regrassed on old bermudagrass planted recreational areas (e.g., golf courses, sports fields, lawns, landscapes, production fields). Undependable control and ineffective elimination of the original bermudagrass sward has resulted in bermudagrass being the number one weedy species. This has led to contamination problems in growing pristine paspalum turfgrass.

Accordingly, there is a need to safely and effectively control and eventually eliminate weedy species from recreationally planted grasses such as Seashore paspalum. In particular, there is a need to control and eliminate persistent weedy species from Seashore paspalum in a timely manner that does not chemically pollute the environment or develop unmanageable, residual toxic contamination levels (e.g., from excess sodium) in the ecosystem.

### SUMMARY OF THE INVENTION

The invention addresses the aforementioned problems by providing methods for controlling the growth of and/or substantially eliminating multiple weedy species such as bermudagrasses in any paspalum planted grass by applying compositions comprising, or alternatively consisting of, chloride-ion containing compounds.

In one aspect, the invention provides methods for controlling the growth of and/or substantially eliminating weedy species by applying a combination of chloride-ion containing compounds, a co-reactive natural herbicide and a fertilizer element(s), said weedy species including, but not limited to, bermudagrass or bermudagrass hybrids.

In another aspect, the invention provides methods for controlling the growth of weedy species by applying compositions comprising chloride-ion containing compounds having chloride concentrations at levels that effectively control and eventually substantially eliminate weedy species, but not at levels that will harm Seashore paspalum or the ecosystem.

In another aspect, the invention provides methods for controlling the growth of weedy species by applying compositions comprising chloride-ion containing compounds having chloride concentrations at levels that effectively control and, with appropriate chelation or carrier complexes, eventually substantially eliminate weedy species, but not at levels that will harm Seashore paspalum or the ecosystem.

In another aspect, the invention provides methods for controlling the growth of and/or substantially eliminating weedy species by applying chloride-ion containing compounds with co-reactive chemical compounds that enhance the effectiveness of moving chlorides directly into weedy specie regenerative organs.

In another aspect, the invention provides methods for controlling the growth of and/or substantially eliminating weedy species by applying chloride-ion containing compounds with beneficial nutrient combinations that will promote the growth and development of Seashore paspalum.

In yet another aspect, the invention provides methods for controlling the growth of and/or substantially eliminating weedy species by applying a combination of chloride-ion containing compounds with other compounds such as reduced level concentrations of herbicides, fertilizers, or other chemicals and/or mechanical cultivation techniques (such as verticutting, slicing, or aggressive grooming) in tandem or sequentially with said chloride-ion containing compounds to enhance the efficacy in controlling and eliminating bermudagrass or other weedy monocot and dicot species.

In yet another aspect, the invention provides a method of developing, managing or maintaining lawns, landscapes, production fields, sports fields or golf course paspalum plantings by administering effective compositions of the invention as described above.

In yet another aspect, the invention provides a method of producing a lawn, landscape, production field, sports field or golf course comprising, cultivating paspalum grass and administering one or more treatments of a composition comprising a chloride ion-containing compound present at a concentration sufficient to control the growth of and/or substantially eliminate weedy species in the treated area(s).

### BRIEF DESCRIPTION OF THE FIGURES

FIG. 1 shows exemplary methods of carrying out the invention and the effect of applying the compositions of the invention.

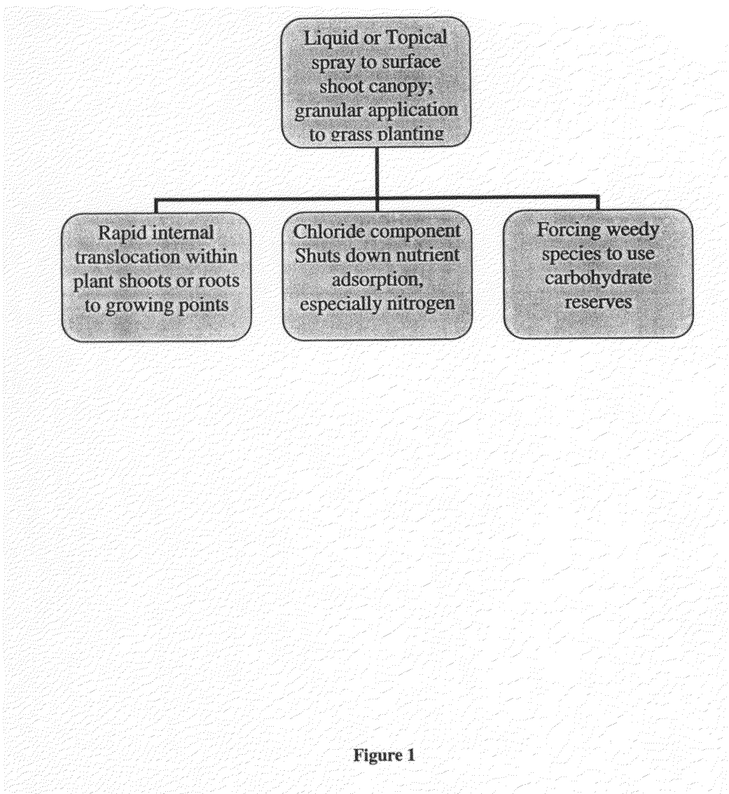

### DETAILED DESCRIPTION OF PREFERRED EMBODIMENTS

As used herein, “chloride-ion containing compound” is a compound that comprises, or alternatively consists of, chloride ions. It is understood that other elements such as, but not limited to, calcium, zinc, potassium, copper and magnesium may be included in the chloride-ion containing compound to form compositions that are useful in carrying out the invention (e.g., compositions comprising calcium chloride, zinc chloride, etc.). However, the “chloride-ion containing compounds” of the invention do not comprise the element sodium. Accordingly, while the chloride-ion containing compound may comprise other elements such as calcium, zinc, potassium, copper or magnesium, the chloride-ion containing compounds do not include the element sodium.

It will be understood by the skilled artisan that sodium ions may previously be present that the site of administration of the “chloride-ion containing compound,” or may even be present in a co-administered form such as, for example, a fertilizer or some other chemical amendment or additive. However, “chloride-ion containing compounds” of the invention lack the element sodium.

For thousands of years, Seashore paspalum has been exposed to chloride levels of 19,000 mg/L (ppm) in ocean water for moisture and nutrition on the beaches of South Africa. As a result, Seashore paspalum is one of the most available salt-tolerant, halophytic turfgrasses. The invention described herein utilizes this natural, inherent salt-tolerance as a basis for providing compositions that control and/or substantially eliminate weedy species, such as bermudagrass. In particular, the invention provides compositions containing, or alternatively consisting of, chloride-ion containing compounds having chloride concentrations at levels that effectively control and/or substantially eliminate competing weedy species, but do not harm paspalum grasses or the ecosystem.

Chlorides are used in very small quantities within most plants as an oxygen scavenger during photosynthesis (water-splitting of Photosystem II in photosynthesis where oxygen is evolved). However, high levels of chlorides will inhibit enzyme activities (ATPase) in photosynthesis and disrupt nitrogen uptake and subsequent utilization, ultimately sequestering toxic levels internally in the growing points of the plant (about 3000-5000 ppm or about 0.30-0.50% by dry weight in leaves), altering stomatal regulation and maintenance of electrical neutrality with cationic solutes (K+ or Na+) and causing tissue dehydration, loss of turgor pressure, tissue desiccation and ultimately death of the sensitive plant, especially in glycophytic grass species such as bermudagrasses.

Typical tissue concentrations of chloride in turfgrasses range from about 1000-6000 ppm or about 0.10-0.60% by dry weight. Salt-tolerant species such as seashore paspalum can tolerate concentrations of chloride of about 2.0% by dry weight or more (e.g., greater than about 20,000 ppm). In particular, Seashore paspalum uses the elevated chloride levels for positive photosynthetic growth and development, without disruption of internal maintenance of nitrogen nutrition or turgor pressure.

Accordingly, the present invention provides a method to effectively control and/or substantially eliminate weedy species from preferred grasses, by applying compositions that comprise, or alternatively consist of, chloride-ion containing compounds having chloride concentrations that are detrimental to undesirable weedy plant species, but are naturally tolerated by other halophytic plant species such as Seashore paspalum.

In one embodiment, the method of the invention employs compositions comprising, or alternatively consisting of, chloride-ion containing compounds that control the growth of weedy species present in the treated area(s).

As used herein, “control” or “controlling” means down regulating normal growth and development processes in weedy species and restraining the competitive capabilities of the weedy species.

In another embodiment, the method of the invention employs compositions comprising, or alternatively consisting of, chloride-ion containing compounds that substantially eliminate weedy species present in the treated area(s).

As used herein, “substantially eliminate” or “substantially eliminating” means removal, exclusion, or eradication of about 90% or greater of a weedy species per cubic meters. In one embodiment, the invention provides a method of substantially eliminating about 95% or greater of a weedy species. In another embodiment, the invention provides a method of substantially eliminating about 99% or greater of a weedy species.

In yet another embodiment, the method of the invention employs compositions comprising, or alternatively consisting of, chloride-ion containing compounds that control the growth of and substantially eliminate weedy species present in the treated area(s).

One advantage of the method of the invention is that it employs compositions that do not adversely affect the environment. In particular, chlorides are extremely mobile in the environment, readily go into solution with irrigation or rainfall, and rapidly infiltrate/percolate through most soil profiles with normal water movement. Chlorides are effectively leached with adequate infiltration and percolation rates in soil profiles; thus, this compound has the least likelihood among the salt ions for buildup in soils or environmentally sensitive ecosystems. The amount of chlorides that will be applied to the grass planted ecosystem from this product technology is minute compared to normal exposure of these same ecosystems to salt spray, stormwater inundation, or salt removal of ice or snow on roadways and the subsequent movement of these salts into irrigation sources to be used on recreational turfgrass plantings or production fields.

Another advantage of methods of the invention is that compositions comprising, or alternatively consisting of, chloride-ion containing compounds that do not contain sodium ions are utilized. Excess sodium leads to specific ion toxicity in plant root tissues and to soil structure deterioration (i.e., sodic or saline-sodic soil). These undesirable outcomes are often the result of irrigation with seawater, brackish and/or other sources of elevated saline water concentrations. Accordingly, by avoiding the use of sodium ions in the form of sodium chloride (e.g., seawater), the invention does not suffer from the drawbacks of using seawater and other types of saline irrigation water.

The chlorides act by shutting down nitrogen uptake, essentially putting the bermudagrass or other weedy species into a starvation mode since nitrogen is a key to its survival, maintenance and sustainability for producing and storing carbohydrates. Once residual carbohydrates stored in the underground rhizomes and shallow stolons of the bermudagrass are depleted, the bermudagrass will not survive or regrow from that plant organ. Uptake of the excess chloride by a weedy glycophytic species such as bermudagrass causes reduced water uptake, severe leaf chlorosis (chlorophyll loss), reduced photosynthesis by inhibiting enzyme activities, leading to tissue dehydration, loss of turgor pressure (wilting), tissue desiccation and depletion of carbohydrate reserves. The extra chloride also serves as a growth stimulant for the paspalum.

The formulated chloride-ion containing compounds useful in the invention will depend on the weedy species to be controlled and/or substantially eliminated. However, the concentration of chlorides formulated in the weed control product of the invention will be miniscule compared to irrigation with sodium chloride-laden saline irrigation, brackish, or ocean water. Typical chloride ranges on current recreational turf vary from 100 ppm in most drinking water to 3000 ppm in brackish aquifer or surface water used for irrigation. In extreme cases in the Middle East, 10,000 ppm chloride from blended ocean water is being applied to paspalum turfgrass grown on sandy soil profiles in order to promote effective leaching and environmental sustainability. However, using these blended ocean water resources also deposits 5000-6000 ppm (217-261 meq/L) of sodium per cycle of irrigation and any level of excess sodium greater than 184 ppm (8 meq/L) must be very carefully managed to minimize long term impact to the soil profile and overall environment. For example, maximum soil chloride concentration (based on saturated soil paste extract data) thresholds for selected grasses include: crested wheatgrass (about 1050 ppm), tall fescue (about 1400 ppm), perennial ryegrass (about 1025 ppm), bermudagrass (about 2450 ppm) and fairway crested wheatgrass (about 2625 ppm). Accordingly, to control and/or substantially eliminate any one of these grasses, compositions of the invention will comprise, or alternatively consist of, chloride-ion containing compounds having a chloride concentration that is greater than the maximum soil chloride concentration for the target weedy species to be controlled and/or eliminated. In one embodiment of the invention, the composition comprises, or alternatively consists of, chloride-ion containing compounds having a chloride concentration between about 2650 ppm and about 20,000 ppm, about 4000 ppm to about 18,000 ppm or about 6,000 ppm to about 16,000 ppm of chloride. In another embodiment, the chloride ion concentration is greater than 6000 ppm or 0.6% by dry weight.

Those of skill in the art may determine the maximum soil and plant chloride concentrations for other weedy species. Chloride concentrations in soils are determined with the saturated paste extract analysis procedure, which is a water extraction procedure that indicates soluble nutrients in soil solution that are supposedly plant available for root uptake. Plant tissue concentrations are determined by the ‘wet chemistry’ or acid extraction of tissue and spectrophotometric analysis of each nutrient, including chlorides, to indicate what the plant actually has taken up, either via the root system or foliarly. Chloride is very mobile in plants, rapidly moving to the growing points internally. Chloride compounds applied in liquid formulations, when applied foliarly to plant canopies, are taken up foliarly through cuticle cracks and stomatal pores, and can be translocated downward (phloem) in the plant to underground organs because of its high mobility as well as upward (xylem and phloem) to shoot and leaf tip growing points. Internally in the plant after uptake, chloride passes directly into cells through the cell wall and plasma membrane, or enter the apoplasm (space between cells) where it may be transported via the xylem or phloem. Compositions comprising, or alternatively consisting of, chloride-ion containing compounds that control and/or substantially eliminate unwanted weedy monocot and dicot species based on the above determinations are also envisioned for use in the invention.

Appropriate chloride concentrations for controlling and/or eliminating weedy species may also be determined using potential phytotoxicity thresholds for soil accumulation and effect on direct root activity or translocation to shoot tissue in sensitive plants. For example, potential phytotoxicity thresholds for soil accumulation and effect on direct root activity or translocation to shoot tissue in chloride sensitive plants are greater than about 10 meq/L or about 355 ppm. Compositions comprising, or alternatively consisting of, chloride-ion containing compounds that control and/or substantially eliminate unwanted weedy monocot and dicot species based on these determinations are also envisioned for use in the invention.

Appropriate chloride concentrations for controlling and/or substantially eliminating weedy species may also be determined using potential phytotoxicity thresholds for direct foliage injury in sensitive plants. For example, potential phytotoxicity thresholds for direct foliage injury in sensitive plants may be about 3 meq/L or about 100 ppm. Compositions comprising, or alternatively consisting of, chloride-ion containing compounds that control or eliminate unwanted weedy monocot and dicot species based on these determinations are also envisioned for use in the invention.

The chloride-ion containing compounds used in the invention may comprise, or alternatively consist of, one or more of a variety of chloride-containing complexes that include, but are not limited to, calcium chloride, potassium chloride, zinc chloride, copper chloride and/or magnesium chloride. However, it is understood that sodium chloride is not encompassed for use in the invention in the chloride-ion containing compound.

In one embodiment of the invention, the composition comprises calcium chloride, potassium chloride and magnesium chloride, wherein the nutritional Ca:Mg ratio is about 3-8:1, the Ca:K ratio of approximately 10-30:1, and the Mg:K ratio is about 3-10:1. These concentrations provide the active chloride ingredient for controlling and/or eliminating a competing weedy species, but would also provide critical nutritional balance and stability for the paspalum. Additional concentrations will be formulated to supply sufficient levels of calcium to counter high sodium levels in soils or from irrigation water, or to counter low calcium levels in irrigation water sources.

The compositions of the invention may also comprise compounds that will enhance the effectiveness of moving the chlorides into and internally within the weedy species. Examples of these compounds include, but are not limited to, chelants, carriers, complexing agents and combinations thereof. Chelants are organic compounds that are formed when a cation or anion is bound by a ring structure. Examples include DTPA, EDTA, EDDHA, HEPTA, CIT, OX, which are known to the skilled artisan. Examples of carriers include oxides, hydroxides, alcohols, sugars, gluconates/glucoheptonates, amino acids and such chemical additions as chlorides, nitrates, sulfates, carbonates and silicates. Complexing agents include polyphosphoric acids, pyrophosphoric acid, triphosphoric acid and polyflavonoids. In another context, biochemical agents used in these formulations can be broken down into the following categories:
1. simple: amino acids, simple sugars
2. complex: polysaccharides, proteins
3. humic substances: humic acids, fulvic acids (that are quite active when formulating foliar uptake compounds), humin, seaweed extracts
4. biostimulants (natural plant extracts or synthetic chemicals that have hormonal properties): cytokinins (normally found in seaweed and Yucca extracts).

The chelant may be present in the acid form or as a water soluble salt. If present as a salt, the chelant should be present as the calcium, magnesium or potassium salt. Preferably, the chelant is present in concentrations of at least 5% potassium or magnesium or at least 10% calcium.

The compositions of the invention may also comprise nutrients that will promote positive growth and development of paspalum grasses. Examples of nutrients that may be added to the compositions used in the invention include, but are not limited to, calcium, potassium, magnesium, zinc copper and combinations thereof. The nutrient is preferably present in concentrations of at least 5% for potassium and magnesium, at least 10% for calcium and 1-2% for zinc and copper. Accordingly, the compositions of the invention will have both weedy species elimination capabilities (from the chloride-ion containing compounds) and paspalum nutritional enhancement from the cations (e.g., calcium, magnesium, potassium, zinc, copper) or possible anion compounds (besides chloride, oxides, hydroxides, carbonates, sulfates or others).

The compositions used in the invention may also comprise one or more additional ingredients such as tackifiers, surfactants (wetting agents), stickers, dispersants, emulsifiers, preservatives, antifreeze agents and solvents, fillers, colorants and carriers, antifoams, evaporation inhibitors, pH and viscosity regulators, other optional ingredients and combinations thereof. More preferably, the compositions useful in the invention further comprise wetting agents, stickers, dispersants, evaporation inhibitors or pH regulators.

A wetting agent, (also referred to herein as “surfactant”), may be used to facilitate uniform movement of the chloride portion of the compound with water movement into the root zone of the weedy species for subsequent root uptake. A very large variety of surfactants are known and commercially available, including such different classes as cationic surfactants, anionic surfactants, non-ionic surfactants, ionic surfactants and amphoteric surfactants. According to the invention, the surfactant can be any surfactant or combination of surfactants useful to suspend particles of chloride. Examples of some preferred surfactants include cationic, non-ionic, and anionic surfactants, either alone or in combinations (e.g., blends of cationic and nonionic surfactants).

In another aspect, the method of the invention employs a chloride composition that is chelated with appropriate carriers to effectively control and eventually eliminate the weedy species such as bermudagrass, while at the same time providing specific nutrients as a nutritional stabilization component for the Seashore paspalum.

The compositions employed in the method according to the invention may be in the form of directly spray aqueous solutions, powders or highly-concentrated aqueous materials for spreading or granular dispersal.

The administration of the compositions employed in the method of the invention may be achieved using methods known in the art. For example, the compositions of the invention may be applied by means of spraying (e.g., conventional liquid formulations for aerial topical and field directed-spray techniques, atomizing) and granular formulation spreading. Mechanical cultivation techniques, such as but not limited to verticutting, slicing, or aggressive grooming, may be used either prior to or in tandem with spray applications of the invention on the undesirable weedy species, such as bermudagrass to escalate use of stored carbohydrates in rhizomes and stolons in the weedy species.

The compositions employed in the method of the invention may be applied by spot-application to undesired plant growth using a hand-held applicator, airbrush spraying, broadcast spraying, or the like. Broadcast application may be effected using directed spray nozzles which enhance the reduction of the size of the droplets, which are emitted during application of the composition as discussed above. The compositions of the invention may be applied to plants, soil or both plants and soil. Preferably, the liquid formulation is applied to plant foliage, for example, the foliage of the target weed such as bermudagrass. Alternatively, the composition may be applied directly to soil, either before, during or after planting a paspalum crop.

In one aspect, the formulated chloride product used in the method of the invention may be liquid and will be boom- or hand-sprayed over the canopy top of the Seashore paspalum and weedy contaminants.

In another aspect, the methods for controlling and/or substantially eliminating weedy species are carried out by topical spraying and directed application specifically to target weedy species, either in combination with sequenced or tandem application of additional chemicals or mechanical cultivation to enhance efficacy, or applied alone for control and eventual elimination of target weedy species.

The method of the invention may be applied to control a wide spectrum of weedy species and in particular, weeds that compete with salt-tolerant grasses such as paspalum. For example, the compositions of the invention may be applied to bermudagrass, bermudagrass hybrids (Cynodon species) and other weedy monocot and dicot plant species. Other examples of other weeds in which the compositions of the invention may be applied to include, but are not limited to, glycophytic grasses such as centipedegrass, St. Augustinegrass, zoysiagrass, carpetgrass, tall/fine/hard fescues, perennial/annual ryegrass, creeping/velvet/colonial bentgrass, bahiagrass, Kentucky/Texas/hybrid bluegrass, Buffalograss, Blue Grama, Wheatgrasses, Alexandergrass, signalgrasses, sandburs, orchardgrass, panicums, dallisgrass, crowfootgrass, crabgrasses, goosegrass, junglerice, torpedograss, annual bluegrass, and broadleaf weeds such as, but not limited to, carpetweed, khakiweed, amaranths, pigweed, chickweeds, ragweeds, cudweeds, dandelion, dichondra, spurges, henbit, beggarweeds, clovers or combinations thereof.

More particularly, the method of the invention may be applied to control weeds in all cultivars, experimental varieties, ecotypes or accessions of Paspalum vaginatum Swartz (Seashore paspalum), including all currently marketed and future cultivars: SeaIsle 1, SeaIsle 2000, SeaIsle Supreme, Seaspray and future seeded hybrids, Seadwarf, Seagreen, Seaway, Salam, Boardwalk, Saltene, Salpas, Velvetene, Neptune, Millennium, Aloha, Neptune, Corrib, Durban, TX515, EE1, 223, Maximo or any other derivation or genetically manipulated selections, regardless of country, region, location, or site where paspalum grass may be planted or grown. It will also be appreciated that paspalum grasses such as Seashore paspalum have a variety of common names including, but not limited to, knotgrass, siltgrass, saltwater grass, biscuitgrass, seaside millet, sheathed paspalum, saltwater couch and water couchgrass. It will also be understood that the methods of the invention may be applied to all current cultivars, experimental or genetically derived ecotypes, accessions from global collections, and any future seeded or vegetatively propagated cultivars of seashore paspalum in natural or planted ecosystems with or without maintenance of the grass.

The invention also comprises the tandem or sequential application of one or more herbicides such as a reduced concentration of PROGRASS® (ethofumesate). For example, the PROGRASS® is either applied prior to or after application of the chloride composition of the invention, on a designated schedule to enhance the effectiveness of the total weed control and elimination strategy. The invention is not limited solely to this herbicide, specific chemical or formulation. Additional growth regulators, herbicides, liquid or granular fertilizers, biostimulants, or other chemicals or natural compounds/complexes may be also be used in the weed control/elimination strategy with consideration for environmental sustainability of the entire turfgrass ecosystem.

The method of the invention may be used in a variety of applications. For example, the method of the invention may be used for recreational turfgrasses (e.g., lawns, landscapes, sports fields, golf courses, lawn bowling greens), vegetative sprig or sod or plug or seed field or greenhouse production, forages for herbivores, land reclamation and bioremediation. In particular, the method is applicable to production fields, lawns/landscapes, or sports fields/golf courses that are exposed to saline water ecosystems, salt spray or saltwater inundation, or inland non-saline ecosystems using alternative irrigation water from all sources.

In one embodiment, the invention provides a broad method of controlling and/or substantially eliminating weedy species in paspalum grass while cultivating or maintaining paspalum grass by applying a chloride ion-containing compound in an amount effective to control the growth of and/or substantially eliminate a weedy monocot or dicot species without harming the paspalum grass. In another embodiment, the invention relates to a method of providing a weed-free or substantially competition-free and weed-free environmentally sustainable turfgrass system. In yet another embodiment, the invention provides for a method of developing, managing and/or maintaining a golf course, sports field, production field, lawn, landscape or any planted area comprising cultivating, high or reduced maintenance of and/or management of paspalum grass and applying a chloride ion-containing compound in an amount effective to control the growth of and/or substantially eliminate a weedy species without harming the paspalum grass or the ecosystem. This embodiment may include additional steps such as selecting a parcel of land (e.g., for field sod or sprig production or to be used as a golf course, sports field or landscape area), selecting a parcel of land near a body of salt water, saline affected ecosystem or any other ecologically sensitive site, cultivating paspalum grass and/or managing the paspalum at a level of expected performance near a body of salt water or when using alternative irrigation sources with varying levels of salinity and nutrients. The methods of the invention may be carried out near a body of salt water, saline affected ecosystem or any other ecologically sensitive site such as less than 1, 5, 10, 25, 50, 100 or 200 or more miles inland from the body of salt water, saline affected ecosystem or any other ecologically sensitive site. Bodies of salt water include, but are not limited to oceans, seas, saline ponds/rivers/canals/lakes/ponds/reservoirs/dams or any other water catchment facility or strata in aquifers, whether coastal or inland, and whether impacted by salinity variations or not. The methods of the invention may also be carried out in sites that are greater than 200 miles inland from a body of salt water, saline affected ecosystem or any other ecologically sensitive site.

In another embodiment, the compositions of the invention are applied periodically. For example, compositions of the invention may be applied periodically as dictated by the hardiness and persistence of the weedy species, as dictated by the effectiveness in controlling and progress toward elimination of the weedy species (e.g., biweekly to monthly during the growing cycle of the weedy species), and in concert with environmental sustainability and stewardship.

It will be clear that the invention may be practiced otherwise than as particularly described in the foregoing description and examples. Numerous modifications and variations of the present invention are possible in light of the above scientific evidence and environmental stewardship considerations, and therefore, are within the scope of the appended claims.

### EXAMPLE 1

### An Exemplary Method of Making Compositions of the Invention

Sole product or mixing calcium chloride, potassium chloride, and magnesium chloride together in one product. The ratio of calcium to magnesium is about 3-8:1, calcium to potassium is about 10-30:1, and the ratio of magnesium to potassium is about 3-10:1. The method may further comprise adding chelants, carriers, complexing agents and/or wetting agents or other additives.

### EXAMPLE 2

### Exemplary Method of Controlling and/or Eliminating Bermudagrass

Compositions comprising chloride ion-containing compounds are applied over the top of bermudagrass-contaminated paspalum. The compositions may be applied twice a week for one month. The bermudagrass turns brown and the paspalum is unaffected. Additional applications may be applied as needed.

As a result of administering the compositions of the invention, the growth of the bermudagrass will be controlled and/or substantially eliminated.

What is claimed is:

1. A method of controlling the growth of a weedy species from paspalum grass comprising,
administering one or more treatments of a composition comprising a chloride ion-containing compound present at a concentration sufficient to control the growth of the weedy species without harming the paspalum grass.

2. The method of claim 1, wherein the weedy species is bermudagrass, a bermudagrass hybrid, other monocot weedy grasses or dicotyledonous broadleaf weeds.

3. The method of claim 2, wherein the weedy species is bermudagrass.

4. The method of claim 1, wherein said paspalum grass is Seashore paspalum.

5. The method of claim 1, further comprising the step of periodically applying the composition.

6. The method of claim 1, wherein said administering comprises topical spraying or atomizing, spreading or granular application.

7. The method of claim 1, wherein said administering comprises boom- or hand-spraying over the canopy top of the paspalum grass and weedy species.

8. The method of claim 1, wherein the administration step is carried out with or without preceding or post-application of sequentially or tandemly applied herbicides, growth regulators, fertilizers, biostimulants, or other chemicals or compounds or mechanical cultivation.

9. The method of claim 1, wherein the composition further comprises a nutrient that promotes the growth of the paspalum grass.

10. The method of claim 1, wherein the composition further comprises a chelating agent or carrier or additive that enhances the uptake of chlorides by the weedy species.

11. The method of claim 1, wherein the composition further comprises a wetting agent.

12. The method of claim 1, wherein the composition comprises calcium chloride, potassium chloride, magnesium chloride, zinc chloride, copper chloride or a combination thereof.

13. A method of substantially eliminating a weedy species from paspalum grass comprising,
administering one or more treatments of a composition comprising a chloride ion-containing compound present at a concentration sufficient to substantially eliminate the weedy species without harming the paspalum grass or the ecosystem.

14. The method of claim 13, wherein the weedy species is bermudagrass, a bermudagrass hybrid, other monocot weedy grasses or dicotyledonous broadleaf weeds.

15. The method of claim 14, wherein the weedy species is bermudagrass.

16. The method of claim 13, wherein said paspalum grass is Seashore paspalum.

17. The method of claim 13, further comprising the step of periodically applying the composition.

18. The method of claim 13, wherein said administering comprises topical spraying or atomizing, spreading or granular application.

19. The method of claim 13, wherein said administering comprises boom- or hand-spraying over the canopy top of the paspalum grass and weedy species.

20. The method of claim 13, wherein the administration step is carried out with or without preceding or post-application of sequentially or tandemly applied herbicides, growth regulators, fertilizers, biostimulants, or other chemicals or compounds or mechanical cultivation.

21. The method of claim 13, wherein the composition further comprises a nutrient that promotes the growth of the paspalum grass.

22. The method of claim 13, wherein the composition further comprises a chelating agent or carrier or additive that enhances the uptake of chlorides by the weedy species.

23. The method of claim 13, wherein the composition further comprises a wetting agent.

24. The method of claim 13, wherein the composition comprises calcium chloride, potassium chloride, magnesium chloride, zinc chloride, copper chloride or a combination thereof.

25. The method of claim 13, wherein the method substantially eliminates about 95% or greater of the weedy species.

26. The method of claim 13, wherein the method substantially eliminates about 99% or greater of the weedy species.

27. A method of controlling the growth of and substantially eliminating a weedy species from paspalum grass comprising,
administering one or more treatments of a composition comprising a chloride ion-containing compound present at a concentration sufficient to control the growth of and substantially eliminate the weedy species without harming the paspalum grass.

28. The method of claim 27, wherein the weedy species is bermudagrass, a bermudagrass hybrid, other monocot weedy grasses or dicotyledonous broadleaf weeds.

29. The method of claim 28, wherein the weedy species is bermudagrass.

30. The method of claim 27, wherein said paspalum grass is Seashore paspalum.

31. The method of claim 27, further comprising the step of periodically applying the composition.

32. The method of claim 27, wherein said administering comprises topical spraying or atomizing, spreading or granular application.

33. The method of claim 27, wherein said administering comprises boom- or hand-spraying over the canopy top of the paspalum grass and weedy species.

34. The method of claim 27, wherein the administration step is carried out with or without preceding or post-application of sequentially or tandemly applied herbicides, growth regulators, fertilizers, biostimulants, or other chemicals or compounds or mechanical cultivation.

35. The method of claim 27, wherein the composition further comprises a nutrient that promotes the growth of the paspalum grass.

36. The method of claim 27, wherein the composition further comprises a chelating agent or carrier or additive that enhances the uptake of chlorides by the weedy species.

37. The method of claim 27, wherein the composition further comprises a wetting agent.

38. The method of claim 27, wherein the composition comprises calcium chloride, potassium chloride, magnesium chloride, zinc chloride, copper chloride or a combination thereof.

39. The method of claim 27, wherein the method substantially eliminates about 95% or greater of the weedy species.

40. The method of claim 27, wherein the method substantially eliminates about 99% or greater of the weedy species.
